(19) United States
(12) Patent Application Publication
(10) Pub. No.: US 2026/0241615 A1
(43) Pub. Date: Aug. 20, 2026

(54) SACRIFICIAL ELEMENT FOR THE PRODUCTION OF RIBBED BODIES OF COMPOSITE MATERIAL

(71) Applicant: ADDYX S.R.L., Montesilvano (PE) (IT)

(72) Inventor: Matteo DI FULVIO, Montesilvano (PE) (IT)

(21) Appl. No.: 19/164,305

(22) PCT Filed: Mar. 5, 2024
(86) PCT No.: PCT/IB2024/052101

§ 371 Date: Sep. 11, 2025

(30) Foreign Application Priority Data
Mar. 16, 2023 (IT) 102023000005034

(51) Int. Cl. B29C 33/52; B29C 33/38; B29C 33/40; B29C 70/44; B33Y 10/00; B33Y 80/00

(52) U.S. Cl. CPC B29C 33/52; B29C 33/3842; B29C 33/40; B29C 70/446; B29K 2829/04; B29K 2831/04; B29K 2995/0062; B33Y 10/00; B33Y 80/00

(57) ABSTRACT

A sacrificial element for producing bodies of composite material, the sacrificial element comprising an outer surface and a plurality of grooves on the outer surface suitable for generating ribs in the body of composite material. The sacrificial element is water-soluble and comprises a polymeric material comprising polyvinyl alcohol in a weight percentage between 80% and 99.7% with respect to the total weight of the sacrificial element, and polyvinyl acetate in a weight percentage between 0.1 % and 10% with respect to the total weight of the sacrificial element.

The present invention relates to a sacrificial element for the production of ribbed bodies of composite material, and specifically to a sacrificial mandrel for the production of hollow bodies with internal ribs.

The sector of reference is the one relative to the industry of composite materials, particularly the production of the hollow bodies (tubular geometries) that are generally used in the automotive, aerospace, marine and sporting goods industries.

Composite bodies are usually fabricated with a technique known as “vacuum bag technique”. Such a technique allows for the production of parts made of composite material by means of lamination, using a mold and a bag attached to the mold. The laminated composite material is interposed between the mold and the bag; when vacuum is applied to the bag, the bag pushes the laminated composite material onto the mold so that the laminated composite material acquires the desired shape.

However, such a technique is impaired by some drawbacks. In fact, the vacuum bag technique does not allow for a lamination on a male mold, since there would be a risk of producing a significant concentration of fiber sheets, which will form the laminated composite part, overlapping each other in a very small area. Such a drawback could therefore result in the poor structural strength of the composite part.

In addition, lamination on a female mold is a very slow process which results in high labor costs.

An additional drawback of the vacuum bag technique is encountered when such a technique is used for the production of hollow complex parts because it has a high rejection rate and a poor process repeatability, which usually depends on the operator performing the processing operation.

In order to overcome the aforementioned drawbacks, another technique that is often used to produce hollow bodies of composite material by lamination consists in using a rotating rubber mandrel around which resin-impregnated fiber sheets are rolled to form the laminated part of composite material.

The shape of the composite part depends on the geometries of the mandrel. Usually, the hardening of the composite part, which is formed of the various resin-impregnated fiber sheets, is performed by placing the part inside an oven or autoclave.

In the production of tubular parts, the rubber mandrel is used with the aid of an external counter-mold. Although lamination with the rubber mandrel is generally done on a female mold, lamination on a male mold is also possible. Unlike the vacuum bag technique, the lamination on a female mold by means of the rubber mandrel produces a lower rejection rate and has a good process repeatability.

However, both the vacuum bag technique and the lamination with the rubber mandrel are impaired by the same drawback, meaning that the two techniques described above are inefficient and sometimes impossible when the parts to be obtained have complex tubular geometries, ribs, knots, considerable sectional changes and/or exit holes with a much smaller section than the maximum section of the part.

On the other hand, a fabrication technique using a plaster mandrel is preferred when hollow bodies with a particular internal surface are to be manufactured, The plaster mandrel technique is similar to the rubber mandrel technique, except for the fact that plaster can be machined in order to give a particular geometry to the part.

Nevertheless, a drawback that impairs the manufacturing technique of laminated composite parts with the plaster mandrel relates to the production and processing of the plaster mandrel. In fact, the plaster mandrel is produced by milling a block of plaster or by casting the plaster in a mold. If the mandrel is made by casting in a mold, the plaster mandrel will be subject to shrinkage, thus jeopardizing the geometry and the final characteristics of the mandrel and/or of the composite part; if the mandrel is made by milling, the production and processing costs of the plaster are very high.

Composite hollow bodies with a carbon exoskeleton consisting of a system of unidirectional fiber ribs, which are topologically optimized, to improve the performance of the parts in terms of stiffness-to-weight, strength-to-weight, and impact-to-weight ratios, are known.

A common practice in the composite materials industry consists in locally adding layers of material, which are known as “reinforcing plies”. Such an operation strengthens the part, but is inefficient in terms of stiffening-to-weight ratio. Otherwise said, it is necessary to add layers with much larger surface areas than the area to be reinforced.

In recent years, additive manufacturing (3D printing) has paved the way for the manufacturing of objects with complex geometries, especially in the field of metal or plastic structures. Due to the almost complete absence of constraints in terms of shape and complexity, additive manufacturing is often the most convenient (or in some instances the only) way to produce metal or plastic objects with a high degree of topological optimization.

US2019351630A1 describes a non-expanding mandrel that therefore does not impart any pressure to the composite laminate. Such a mandrel has only the function of acting as a support for the deposition of dry fibers and for the subsequent resin infusion process (at low temperature) and needs to be covered by bag. In fact, such a mandrel cannot be used at high temperature, and therefore it cannot be used in an autoclave or press process.

US2021 162688A1 describes a method for forming vascular components with a composite sacrificial body.

CN108115948A describes an internally hollow mandrel made of composite material.

US5266137AU describes a rigid mandrel having a plurality of elongated sector-shaped pieces arranged side by side to form a peripheral wall of a hollow shell.

EP3892435A1 describes a hybrid spindle used to form a composite part that comprises a core and a sleeve arranged around the core.

WO2013126981A1 describes a manufacturing method of a part from a hardenable material, such as a flexible fiber-reinforced polymer.

The purpose of the present invention is to overcome the drawbacks of the prior art by providing a sacrificial element that is versatile and suitable for being used to obtain composite ribbed bodies with a complex geometry.

Another purpose is to provide such a manufacturing process of composite ribbed bodies that is reliable, repeatable, efficient, and easy to implement.

These purposes are achieved in accordance with the invention with the features listed in the attached independent claims.

Advantageous embodiments appear from the dependent claims.

The sacrificial element according to the invention is defined by the independent claim 1.

Further features of the invention will appear clearer from the detailed description that follows, referring to its purely illustrative and therefore non-limiting embodiments, illustrated in the attached drawings, wherein:

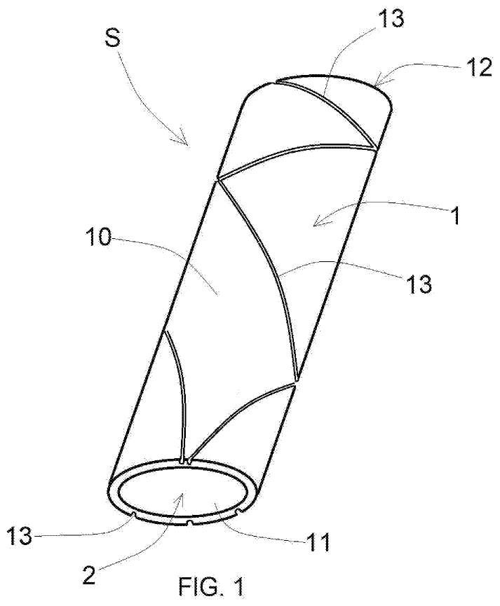

FIG. 1 is a perspective view of a sacrificial element according to the invention, in the form of a sacrificial mandrel;

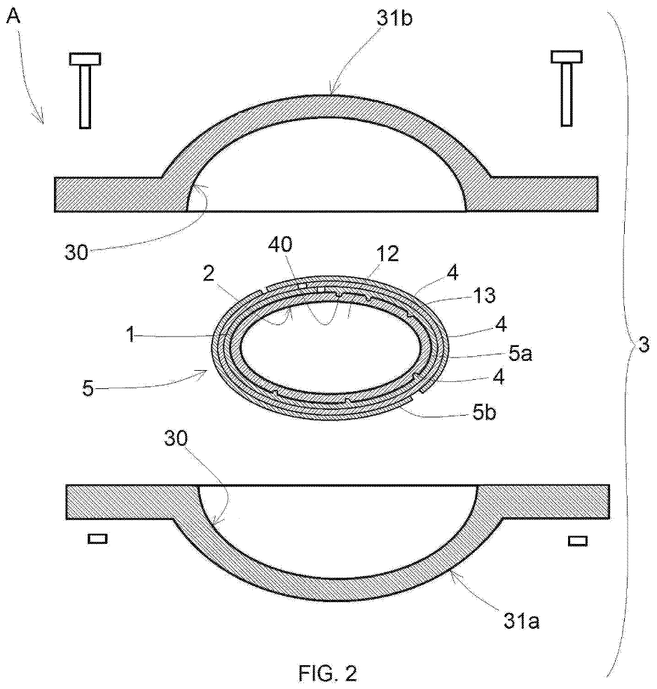

FIG. 2 is an axial view of an open mold wherein the sacrificial mandrel of FIG. 1 is arranged and wrapped with fiber sheets;

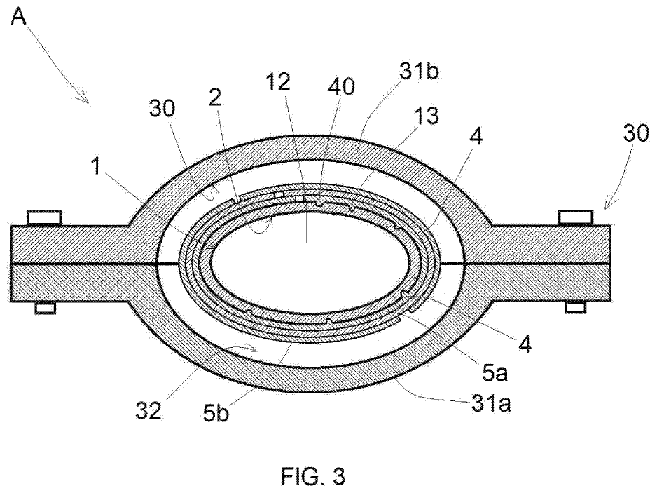

FIG. 3 is an axial view of the closed mold in FIG. 2, before the expansion of the sacrificial mandrel;

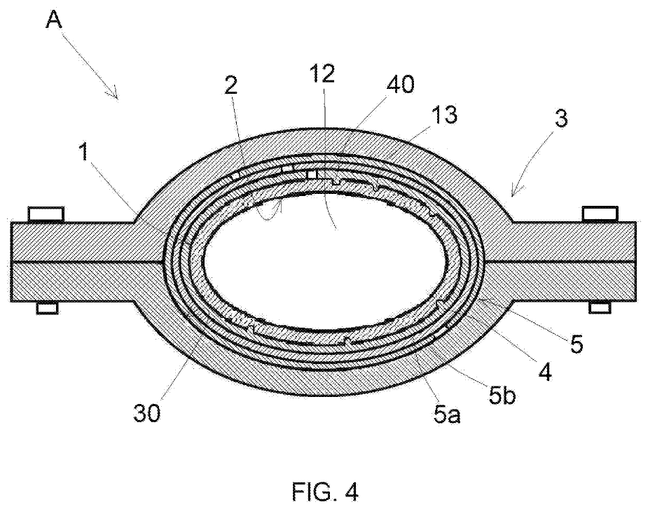

FIG. 4 is an axial view of the closed mold in FIG. 3 at the end of the expansion of the sacrificial mandrel;

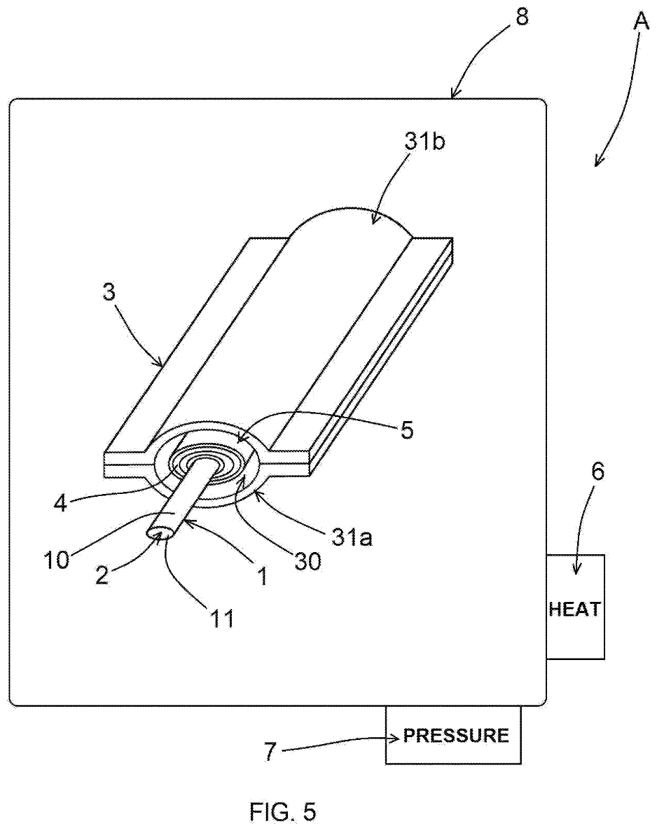

FIG. 5 is a diagrammatic view of an apparatus for the manufacturing process of a hollow body with internal ribs according to the invention;

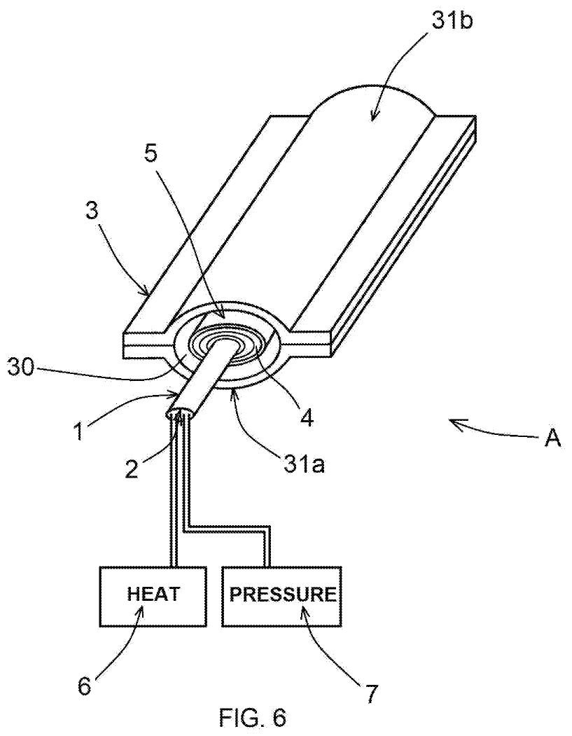

FIG. 6 is a diagrammatic view of a variant of the apparatus of FIG. 5;

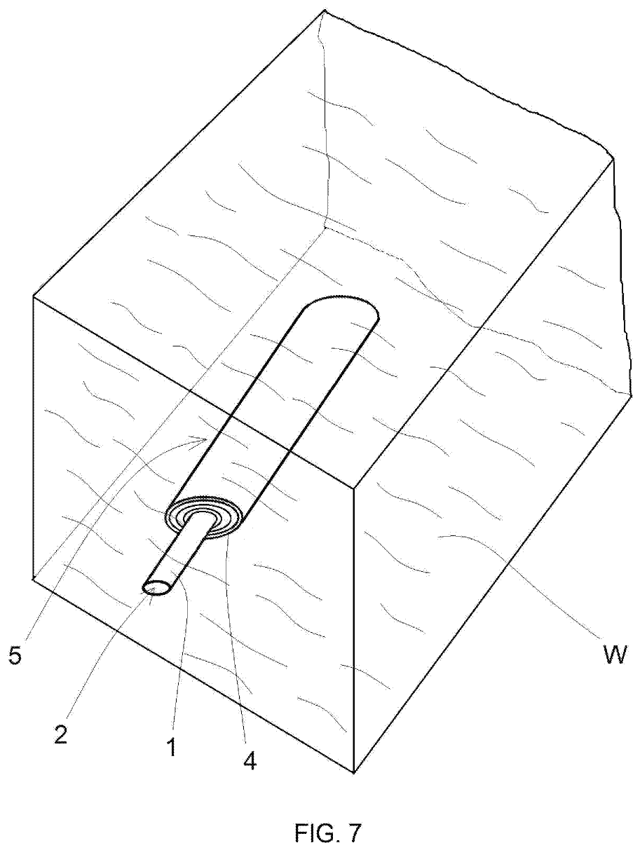

FIG. 7 is a diagrammatic perspective view illustrating the hollow body arranged on the sacrificial mandrel that was extracted from the apparatus of FIG. 5 and immersed in a water tub for the solubilization of the sacrificial mandrel;

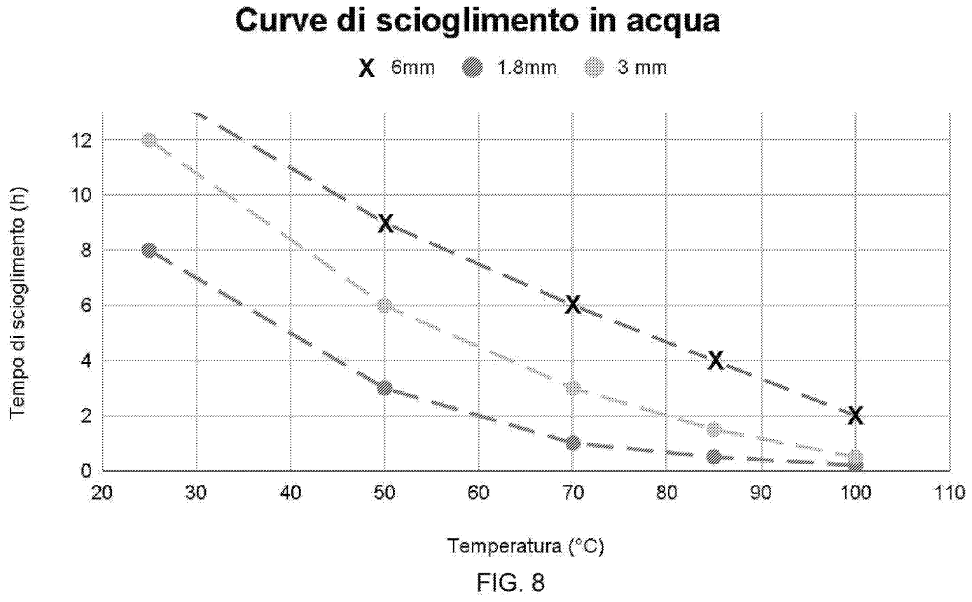

FIG. 8 is a chart illustrating the solubilization time of the sacrificial element as a function of the water temperature and of the thickness of the sacrificial element;

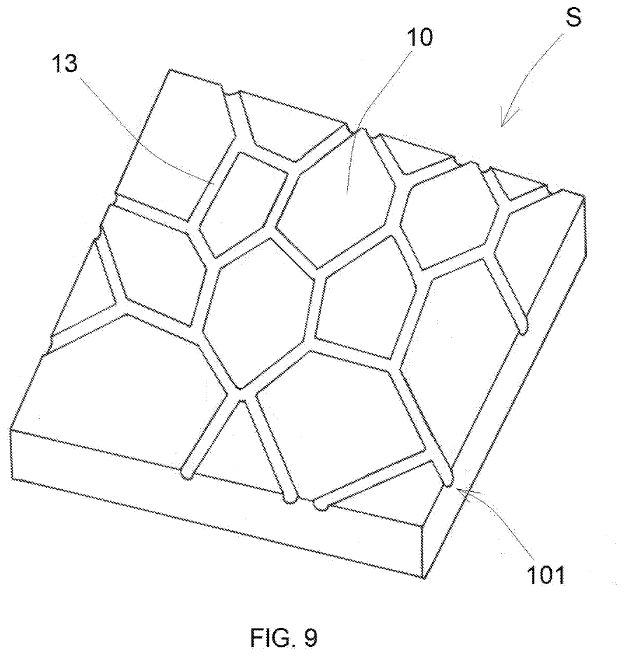

FIG. 9 is a perspective view of a second embodiment of the sacrificial element in the form of a sacrificial plate;

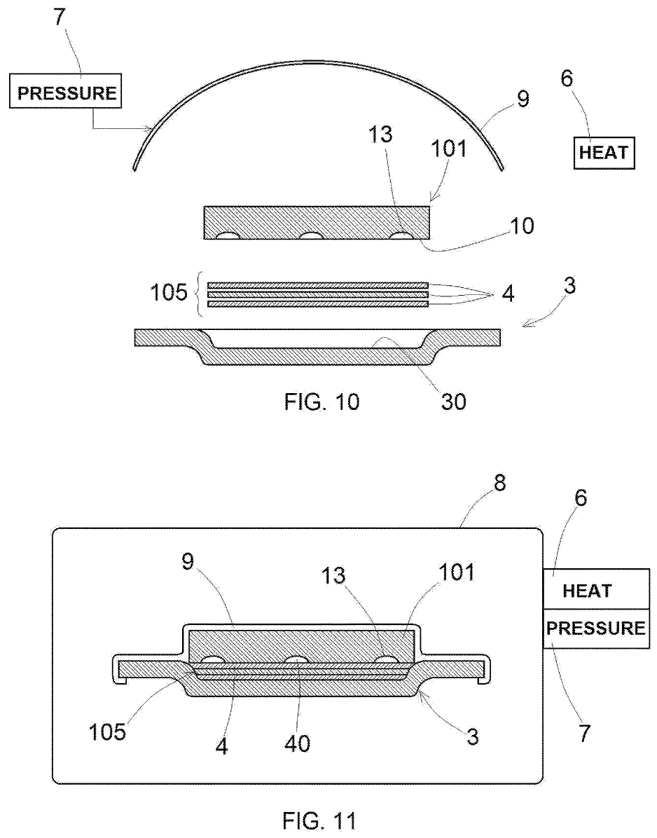

FIG. 10 is an exploded axial view illustrating a mold, fiber sheets, the sacrificial plate of FIG. 9, and a vacuum bag; and

FIG. 11 is the same view as FIG. 9, during a depression in the vacuum bag inside an autoclave.

FIG. 1 illustrates a sacrificial element(S) according to the invention in the form of a sacrificial mandrel (1). A sacrificial element is defined as an element made of a material suitable for being disposed of after use, in this case a water-soluble material.

As shown in FIG. 2, the sacrificial mandrel (1) is suitable for being wrapped with resin-impregnated fiber sheets (4) in such a way to obtain a laminated hollow body (5) of composite material.

As shown in FIG. 4, the sacrificial mandrel (1) is suitable for expanding inside a mold (3) to increase in diameter and cause a compression of the sheets (4) and a polymerization of the resin so as to obtain the hollow body (5) made of composite material.

Returning to FIG. 1, the sacrificial mandrel (1) has a tubular shape with an outer surface (10). The sacrificial mandrel (1) is internally hollow with an axial channel (2) provided at the front with an opening (11). The axial channel (2) is posteriorly closed by a rear wall (12) or a plug.

The sacrificial mandrel (1) has a variable outer diameter depending on the hollow body to be made; by way of example, the outer diameter of the sacrificial mandrel can vary from 5 mm to 50 cm. The thickness of the sacrificial mandrel can vary from 1 mm to 5 mm.

A plurality of grooves (13) is obtained in the outer surface (10) of the sacrificial mandrel. The grooves (13) have a pattern and a depth according to the arrangement, shape and size of the internal ribs to be obtained in the hollow body to be made. For illustration purposes, the grooves (13) may have a depth of about 40%-60% of the thickness of the sacrificial mandrel.

The sacrificial mandrel (1) is water-soluble and is made of a polymer material composition. The polymer material composition of the sacrificial mandrel (1) comprises:
polyvinyl alcohol in a weight percentage between 80% and 99% with respect to the total weight of the composition; and
polyvinyl acetate in a weight percentage between 0.1% and 10%.

The polymer material composition of the sacrificial mandrel (1) may also comprise latex in a percentage between 0.1% and 20% and/or polyurethane rubber in a percentage between 0.1% and 5%.

The sacrificial mandrel (1) is made in three steps: 3D printing, heating and sealing.

The first step of 3D printing is performed with a technique known as “additive manufacturing,” using a 3D printer provided with a head with a nozzle capable of depositing layers of material on a bed arranged in a chamber. The temperature of the nozzle of the 3D printer is 195°-210° C. The temperature of the bed is adjustable in the range of 20°-65° C. The temperature of the chamber is adjustable in the range of 15°-65° C. The speed of the head with the nozzle is 15 to 150 mm/s.

Thus, the sacrificial mandrel (1) has a plurality of layers adhered together. The 3D printing confers a high degree of freedom in designing the grooves (13) of the sacrificial mandrel and consequently the ribs of the finished part because the sacrificial mandrel (1) can be made by means of 3D printing with more or less complex geometries.

In the case of the sacrificial mandrel in FIG. 1, the advantage of using the 3D printing allowed the applicant to make laminated hollow bodies with a male element (the sacrificial mandrel (1) in FIG. 1), characterized by complex hollow geometries that may have knots, section changes, exit holes, with a smaller section than the maximum section of the part, and even internal ribs.

In particular, unlike the plaster mandrels of the prior art, the sacrificial mandrel (1) according to the invention is not obtained by filling its volume, but comprises layers with internal ribs/grooves (not visible in the figure that shows a single layer of the mandrel) obtained longitudinally or transversely on some layers that form the mandrel and are made during the 3D printing. The internal ribs/grooves harden the structure of the sacrificial mandrel (1) due to an excellent lamination of the composite material on the sacrificial mandrel (1), without affecting the pressure expandability and the temperature of the sacrificial mandrel (1).

The step of heating provides for heating the sacrificial mandrel in an oven at a temperature of 70° C. for 1.5 hours.

After the heating, the sacrificial mandrel is cooled at room temperature and is sealed with a sealing mixture. The sealing mixture comprises:
water in a weight percentage of 70-80% relative to the weight of the sealing mixture;
polyvinyl alcohol in a weight percentage of 20-29% relative to the sealing mixture; and
polyvinyl acetate in a weight percentage of 1-10% relative to the weight of the sealing mixture.

The sealing mixture may also comprise polyurethane rubber and/or latex.

The step of sealing is performed by carrying out the following cycle for a maximum of three times:
immersion of the sacrificial mandrel in the sealing mixture or application of the mixture by spray or brush,
drying in the oven at 50° C. for 0.5 h, and
cooling at room temperature.

In this way a sealing layer of about 15-35 μm is obtained.

Instead of being contained in the sealing mixture, the polyurethane rubber and the latex can be applied to the outer surface of the mandrel even after the immersion of the mandrel in the sealing mixture.

After the sealing of the sacrificial mandrel, the following steps are performed:
final heating at a temperature of 50°-70° C.
cooling at room temperature, and
storage in a transparent, heat-sealed, vacuum-sealed bag containing silica to avoid moisture absorption as much as possible.

The polyvinyl alcohol, with which the sacrificial mandrel (1) is almost entirely made, gives the mandrel the characteristic of being water-soluble. In fact, once the composite part has been made, the sacrificial mandrel, which adheres to the part, is removed gently in order to obtain a finished part.

Due to its solubility in water, the sacrificial mandrel (1) is dissolved in order to be completely and easily removed from the finished part. By dissolving in water, the sacrificial mandrel (1) is not trapped in the structure of the part, thus enabling the fabrication of hollow bodies and of bodies with undercuts, knots and/or ribs, so as to facilitate the removal of any mandrel residues in correspondence with said undercuts, knots and/or ribs. In fact, the sacrificial mandrel (1) can be completely removed from the finished part.

The complete removal of the sacrificial mandrel (1) is a function of the dissolving time of the material of the sacrificial mandrel, which depends on the thickness of the sacrificial mandrel and on the conditions of the water used to dissolve the sacrificial mandrel, i.e., the temperature of the water and the mechanical action of the forced recirculation of the water on the sacrificial mandrel.

Dissolution tests conducted on a sacrificial mandrel with 2.5 mm thickness showed a dissolution time of approximately six hours in still water at a temperature of 15° C. to 18° C.

FIG. 8 shows a chart illustrating the dissolution time of the sacrificial mandrel (1) based on the temperature of the water in contact with the sacrificial mandrel and on the thickness of the sacrificial mandrel.

Referring to FIG. 2, a plurality of sheets (4) is wrapped around the sacrificial mandrel (1) in such a way to obtain a hollow body (5) made of laminated composite material in multiple layers. Each sheet (4) comprises resin-impregnated fibers, such as carbon fibers impregnated with polyurethane resin.

One or more sheets (4) are wrapped around the outer surface (10) of the sacrificial mandrel so as to obtain an inner layer (5a) of the hollow body. A plurality of sheets (4) is wrapped around the inner layer (5a), overlapping each other, depending on the thickness of the part to be obtained, until an outer layer (5b) of the composite part comprising one or more sheets (4) is obtained.

It should be noted that the sheets (4) of the inner layer (5a) are located on the grooves (13) of the sacrificial mandrel. Therefore, internal ribs (40) are created at the grooves (13) of the sacrificial mandrel, in the sheets (4) of the inner layer (5a) of the hollow body (5), said ribs (40) corresponding to the internal ribs of the composite part to be obtained.

Fibers, such as carbon fibers, arranged unidirectionally along the length of the groove can be inserted into the grooves (13) of the sacrificial mandrel in order to produce unidirectional fiber ribs on the final composite part.

An apparatus (A) comprising a mold (3) is used to compact and join the sheets (4) together. The mold (3) comprises two half-shells (31a, 31b) that define a cavity (30) having the outer shape of the composite part to be obtained. Referring to FIG. 3, the sacrificial mandrel (1) wrapped with the sheets (4) is placed in the cavity (30) of the mold, so that an annular gap (32) is defined around the composite body (5) between the outer surface of the outer layer (5b) of the composite part and the inner surface of the cavity (30) of the mold.

The annular gap (32) has a smaller width than the radial expansion of the sacrificial mandrel (1). Laboratory tests have shown that a sacrificial mandrel (1) having a thickness of 2.5 mm can radially expand to a maximum of 2.8 mm. Therefore, in such a case, the gap (31) between the outer layer (5b) of the composite part and the cavity (30) of the mold can have a width of 2.5 mm to ensure the compression of the sheets (4) wrapped around the sacrificial mandrel.

FIG. 4 shows the sacrificial mandrel (1) after its expansion, in which the sheets (4) are compressed between the sacrificial mandrel (1) and the cavity (30) of the mold.

Referring to FIG. 5, the apparatus (A) comprises heating means (6) and pressure control means (7) operatively connected with the sacrificial mandrel (1) to heat the sacrificial mandrel (1) and generate a pressure in the axial channel (2) of the sacrificial mandrel so that the sacrificial mandrel (1) is dilated and expanded, increasing its diameter, and thereby compressing the sheets (4) between the outer surface (10) of the sacrificial mandrel and the cavity (30) of the mold.

Preferably, the heating means (6) and the pressure control means (7) are connected to an autoclave (8) wherein the mold (3) is arranged. The opening (11) of the axial channel (2) of the sacrificial mandrel is open in the autoclave (8) so that the temperature and the pressure set by the heating means (6) and by the pressure control means (7) are obtained in the axial channel (2) of the sacrificial mandrel.

With reference to FIG. 6, as an alternative to the autoclave (8), the heating means (6) and the pressure control means (7) can be directly connected to the axial channel (2) of the sacrificial mandrel.

The heating means (6) heat the sacrificial mandrel to a temperature (70° to 180° C.) that is higher than the glass-transaction temperature of the sacrificial mandrel and is lower than the melting temperature of the sacrificial mandrel. The pressure control means (7) provide a pressure of 3 to 8 bar in the axial channel of the sacrificial mandrel, which is sufficient for the expansion of the sacrificial mandrel.

The polymerization time of the hollow body (5) inside the mold (3) can be approximately 50-400 minutes. Then the mold is opened and the sacrificial mandrel (1) with the polymerized hollow body (5) is extracted from the mold.

As shown in FIG. 7, the assembly comprising the sacrificial mandrel (1) and the hollow body (5) is immersed in a tank of water (W), so that the water (W) enters the axial channel (2) of the sacrificial mandrel, dissolving the sacrificial mandrel (1) in such a way to obtain the hollow body (5). The water (W) in the tank can be stirred and heated to temperatures around 80°-100° C. in order to accelerate the dissolving process of the sacrificial mandrel. Alternatively, pressurized water can be introduced into the axial channel (2) of the sacrificial mandrel

The manufacturing process of a hollow body (5) made of composite material comprises the following operational steps:
provision of a sacrificial mandrel (1) provided with grooves (13) on the outer surface;
wrapping of the sacrificial mandrel (1) with the sheets (4) of resin-impregnated fibers suitable for forming the hollow body (5) of composite material;
positioning of the sacrificial mandrel (1) inside a cavity (30) of a mold (3);
closing of the mold (3);
operation of the heating means (6) to heat the sacrificial mandrel (1) and cause its thermal expansion;
operation of the pressure control means (7) to introduce pressure into the axial channel (2) of the sacrificial mandrel in order to cause a further expansion of the sacrificial mandrel and push the sheets (4) against the cavity (30) of the mold (3), obtaining a resin polymerization and a final geometry of the hollow body (5) of composite material provided with internal ribs (40) in correspondence with the grooves (13) of the sacrificial mandrel;
opening of the mold (3) and extraction of the hollow body (5) of composite material from the mold (3), around the sacrificial mandrel (1); and
dissolution of the sacrificial mandrel (1) in aqueous solution, so that only the hollow body (5) of composite material is obtained.

Specifically, the steps of heating and pressurization of the sacrificial mandrel occur simultaneously in the autoclave (8) in a period of time comprised between 50 and 450 minutes. The sacrificial mandrel (1) is heated by the heating means (6) to a temperature comprised between 70° C. and 180° C., whereas the pressure control means (7) are operated in order to introduce a pressure between 3 and 9 bar into the axial channel (2) of the sacrificial mandrel. Such working conditions are maintained inside the autoclave (8) and the pressure is increased by one bar every 10 minutes during this period of time.

At the temperature of 70° C.-180° C., and at the pressure of 3-9 bar, the sacrificial mandrel (1) is expanded, pushing the sheets (4) of resin-impregnated fibers onto the cavity (30) of the mold (3), in such a way to obtain the polymerization of the resin of the sheets and the desired geometry of the part. The polymerization time can be approximately 50 -450 minutes.

During the autoclave cycle, at the temperature of 70° C.-180° C., and at the pressure of 3-9 bar, firstly the sacrificial mandrel (1) is softened because the glass transition temperature of about 70° C. is exceeded, and then is expanded because of the viscous sliding caused by the pressure, which is gradually raised. The viscous sliding caused by the pressure pushes the mandrel toward the cavity (30) of the mold (3). In such a process, however, the sacrificial mandrel (1) remains in a solid state since its melting temperature is about 210° C.

Advantageously, with reference to FIG. 4, the step of lamination or layering of the sheets (4) around the sacrificial mandrel (1) is performed in such a way that it does not produce the overlapping of the edges of the sheets (4) on the sacrificial mandrel (1). In particular, the junction points between one sheet (4) and the other are disposed along the entire section of the part, rather than being concentrated in a single narrow area of the mold (3), such as the junction area between the two half-shells (31a, 31b), as it traditionally occurs in the prior art. In such a way, the part will enjoy an excellent structural integrity.

FIG. 9 illustrates a sacrificial element(S) according to a second embodiment of the invention. In this case, the sacrificial element(S) is a sacrificial plate (101) that does not have a tubular shape, but has a flat, concave and/or convex shape without any axial channel or internal chamber. The sacrificial plate may have flat, concave, convex, and/or undulating portions. The sacrificial plate (101) may have a thickness comprised between 2 and 5 mm, just like the sacrificial mandrel.

In each case, the sacrificial plate (101) has an outer surface (10) suitable for going in contact with the body of composite material to be obtained.

Grooves (13) are formed in the outer surface (10) of the sacrificial plate (101), as described for the sacrificial mandrel (1).

The sacrificial plate (101) is made from the same material and with the same process described for the manufacturing of the sacrificial mandrel (1).

Referring to FIG. 10, the sacrificial plate (101) is suitable for being disposed in a mold (3) with a cavity (30) on which sheets (4) of resin-impregnated fibers are arranged to form the body (105) made of composite material. Fibers arranged unidirectionally along the groove can be disposed in the grooves (13) of the sacrificial plate (101). In such a way, the body (105) of composite material will have ribs (40) consisting of unidirectionally arranged fibers.

The sacrificial plate (101) is heated by means of heating means (6).

The sacrificial plate (101) is pressed onto the sheets (4) by means of pressure control means (7) acting on a vacuum bag (9). In this way, by creating a depression on the vacuum bag (9), a compression of the sheets (4) in the cavity (30) of the mold and a polymerization of the resin are caused in such a way to obtain a body (105) of composite material that is not internally hollow. With reference to FIG. 11, the assembly comprising the mold (3), sheets (4), the sacrificial plate (101) and the vacuum bag (9) can be placed inside an autoclave (8). In such a case, the autoclave (8) comprises the heating means (6) and the pressure control means (7).

With reference to FIGS. 10 and 11, a manufacturing process of a body (105) made of composite material with the sacrificial plate (101) is described. Such a process comprises the following operational steps:
provision of a sacrificial plate (101) having an outer surface (10) with grooves (13);
arrangement of a plurality of sheets (4) of resin-impregnated fibers in a cavity (30) of a mold, overlapping each other, to form a body (105) made of composite material;
arrangement of the sacrificial plate (101) with the outer surface (10) and the grooves (13) facing said sheets (4) in the cavity (30) of the mold (3);
operation of the heating means (6) to heat the sacrificial plate (101);
operation of the pressure control means (7) so that the sacrificial plate (101) compresses said sheets (4) against the cavity (30) of the mold (3), resulting in resin polymerization and a final geometry of the body (105) of composite material provided with ribs (40) in correspondence with the grooves (13) of the sacrificial plate; and
dissolution of the sacrificial plate (101) in aqueous solution so that only the body (105) of composite material is obtained.

The advantages of the present invention, which provides a sacrificial element(S) for the fabrication of ribbed bodies, particularly for parts used in aerospace or automotive applications which require high mechanical performance and low weight, are manifest. A further advantage of the present invention consists in the repeatability of the fabrication process of a body of composite material with the sacrificial element(S) according to the invention.

Equivalent variations and modifications may be made to the present embodiments of the invention, within the reach of an expert of the field, which nevertheless fall within the scope of the invention as expressed by the appended claims.

1. Sacrificial element for producing bodies of composite material, said sacrificial element comprising an outer surface and a plurality of grooves on the outer surface suitable for generating ribs in the body of composite material;
said sacrificial element being water-soluble and comprising a polymeric material comprising:
polyvinyl alcohol in a weight percentage between 80% and 99.7% with respect to the total weight of the sacrificial element; and
polyvinyl acetate in a weight percentage between 0.1% and 10% with respect to the total weight of the sacrificial element.

2. The sacrificial element of claim 1, wherein said polymeric material comprises latex in a weight percentage between 0.1 and 20% with respect to the total weight of the sacrificial element and/or polyurethane rubber in a weight percentage between 0.1% and 5% with respect to the total weight of the sacrificial element.

3. The sacrificial element of claim 1, wherein said sacrificial element is fabricated by means of 3D printing and comprises a plurality of layers of said polymeric material that are adhered to each other, and a sealing layer obtained with a sealing mixture comprising water, polyvinyl alcohol and polyvinyl acetate.

4. The sacrificial element of claim 1, wherein said sacrificial element is a sacrificial mandrel having an internally hollow tubular shape with an axial channel

5. The sacrificial element of claim 1, wherein said sacrificial element is a sacrificial plate having a flat, concave and/or convex shape.

6. Manufacturing process of a sacrificial element according to claim 1, comprising the following steps:
3D printing of the sacrificial element by means of a plurality of layers of said polymeric material;
heating of the sacrificial element in an oven; and
sealing by means of a sealing mixture comprising water, polyvinyl alcohol, and polyvinyl acetate.

7. Apparatus for producing bodies of composite material, comprising:
a sacrificial element according to claim 1;
a mold having a cavity suitable for accommodating a plurality of sheets of resin-impregnated fibers overlapping each other and said sacrificial element with the outer surface and the grooves of the sacrificial element facing toward said sheets;
heating means for heating the sacrificial element; and
pressure control means to exert a pressure on the sacrificial element so as to compress said sheets against the cavity of the mold obtaining a polymerization of the resin and a final geometry of the body of composite material provided with ribs in correspondence with the grooves of the sacrificial element.

8. The apparatus of claim 7, wherein said sacrificial element is a sacrificial mandrel having an internally hollow tubular shape with an axial channel and said pressure control means are configured to introduce pressure into the axial channel of the sacrificial mandrel to cause the sacrificial mandrel to expand radially and push the sheets against the cavity of the mold.

9. The apparatus of claim 7, wherein said sacrificial element is a sacrificial plate having a flat, concave and/or convex shape and said pressure control means operate on a vacuum bag disposed on said sacrificial plate in the cavity of the mold so as to create a depression on the vacuum bag and compress the sheets between the sacrificial plate and the cavity of the mold.

10. The apparatus of claim 7, comprising an autoclave wherein the mold is disposed and said autoclave comprises said heating means and said pressure control means.

11. Manufacturing process of a hollow body of composite material comprising the following steps:
providing a sacrificial mandrel according to claim 4;
wrapping the sacrificial mandrel with the sheets of resin-impregnated fibers suitable for making a hollow body of composite material;
lacing the sacrificial mandrel in a cavity of a mold;
closing the mold;
operating the heating means to heat the sacrificial mandrel and make it expand thermally;
operating the pressure control means to introduce pressure into the axial channel of the sacrificial mandrel to make the sacrificial mandrel expand further and push the sheets against the cavity of the mold obtaining a polymerization of the resin and a final geometry of the hollow body of composite material provided with internal ribs in correspondence with the grooves of the sacrificial mandrel;
opening the mold and extracting the hollow body of composite material, which is polymerized around the sacrificial mandrel from the mold;
dissolving the sacrificial mandrel in aqueous solution so that only the hollow body composite material is obtained.

12. Manufacturing process of a body of composite material comprising the following steps:
providing a sacrificial plate according to claim 5;
arranging a plurality of sheets of resin-impregnated fibers, overlapping each other, on a cavity of a mold to form a body of composite material;
placing the sacrificial plate with the outer surface and the grooves facing said sheets in the cavity of the mold;
operating the heating means to heat said sacrificial plate;
operating the pressure control means on the sacrificial plate so that the sacrificial plate compresses said sheets against the cavity of the body of composite material provided with ribs in correspondence with the grooves of the sacrificial plate; and
dissolving the sacrificial plate in aqueous solution, such that only the body made of composite material is obtained.

13. The manufacturing process of a body of composite material according to claim 12, wherein said process comprises the step of filling the grooves of the sacrificial element with fibers arranged unidirectionally along the groove.
